(19) United States
(12) Patent Application Publication
(10) Pub. No.: US 2007/0092262 A1
(43) Pub. Date: Apr. 26, 2007

(54) Adaptive optical transmitter for use with externally modulated lasers

(76) Inventors: Donald Bozarth, Southampton, NJ (US); Joseph Hober, Southampton, PA (US)

Correspondence Address: CHRISTIE, PARKER & HALE, LLP, PO BOX 7068, PASADENA, CA, 91109-7068, US

(21) Appl. No.: 11/258,732

(22) Filed: Oct. 25, 2005

(51) Int. Cl. H04B 10/00

(52) U.S. Cl. 398/159

(57) ABSTRACT

An optical transmitter for generating a modulated optical signal for transmission over dispersive fiber optic links in which a broadband radio frequency signal input is applied to first and second RF inputs of an external modulator for modulating the output of a semiconductor laser. The transmitter includes a digital signal processor coupled to the output of the modulator for independently adjusting the DC bias of the first and second RF inputs to control a characteristic of the optical signal, such as noise associated with composite second order (CSO) distortion as a remote receiver.

### BACKGROUND OF THE INVENTION

1. Field of the Invention

This invention relates to optical transmitters for analog RF signals, and in particular to externally modulated solid state lasers. More particularly, the invention relates to the use of an electronic circuit coupled to the external modulator of the laser for adapting the bias of the modulator to the number and types of the applied broadband RF signal.

2. Description of the Related Art

Modulating the analog intensity of the optical signal from a light-emitting diode (LED) or semiconductor laser with an electrical signal is known in the art for transmitting analog signals, such as sound and video signals, on optical fibers. Although such analog techniques have the advantage of significantly smaller bandwidth requirements than digital pulse code modulation, or analog or pulse frequency modulation, amplitude modulation may suffer from noise and nonlinearity of the optical source.

For that reason, direct modulation techniques have been used in connection with 1310 nm lasers where the application is to short transmission links that employ fiber optic links with zero dispersion. For applications in metro and long haul fiber transmission links the low loss of the link requires that externally modulated 1550 nm lasers be used, but such external modulation techniques are a complex and expensive mixture of the number and type of RF channels, with modulation types ranging from analog to QAM. The present invention is therefore addressed to the problem of providing an adaptive system for adjusting the bias of the external modulator of a laser so that the optical output signal can be used in single mode fiber used in metro and long haul optical networks.

### SUMMARY OF THE INVENTION

1. Objects of the Invention

It is an object of the present invention to provide an improved optical transmission system using externally modulated lasers.

It is another object of the present invention to provide an external modulator for use in a 1550 nm analog optical transmission system utilizing two series connected modulators.

It is also an another object of the present invention to provide a microcontroller to independently adjust the bias of an externally modulated laser used in a 1550 nm analog or QAM optical transmission system for broadband RF.

It is still another object of the present invention to provide an adaptive system for adjusting the DC bias and pilot tones of linear analog optical transmission systems suitable for long haul dispersive optical fiber media.

It is still another object of the present invention to provide a real time digital signal processor control circuit for controlling the optical characteristics of the optical signal from an externally modulated laser.

2. Features of the Invention

Briefly, and in general terms, the present invention provides an optical transmitter for generating a modulated optical signal for transmission over a fiber optic link to a remote receiver comprising a semiconductor laser for reproducing an optical signal; an external modulator for modulating the optical signal with a broadband analog radio frequency (RF) signal; and bias adjustment means connected to the input of the external modulator for adapting the modulation characteristics of the external modulator to minimize distortion in the received signal at the remote receiver.

In another aspect, the present invention provides an optical transmitter for generating a modulated optical signal for transmission over a dispersive fiber optic link to a remote receiver having an input for receiving a broadband radio frequency signal input; a semiconductor laser for producing an optical signal to be transmitted over an optical fiber; and an external modulator for modulating the optical signal with the analog signal including first and second RF inputs. A predistortion circuit is coupled to the second RF input for reducing the distortion in the signal present at the receiver end of the fiber optic link.

In another aspect, the present invention provides an optical signal output from the modulator which causes the received signal at the other end of the transmission system to compensate for the effect of composite second order (CSO) distortion generated in the dispersive optical fiber link, which results in noise in the received signal and unacceptable quality in the demodulated RF signal for standard AM modulated broadcast CATV channels.

### BRIEF DESCRIPTION OF THE DRAWINGS

FIG. 1 is a block diagram of an optical transmitter for generating a modulated optical signal in accordance with an illustrated embodiment of the invention; and

FIG. 2 is a detailed view of a modulator bias controller of the transmitter of FIG. 1.

### DESCRIPTION OF THE PREFERRED EMBODIMENT

Details of the present invention will now be described, including exemplary aspects and embodiments thereof. Referring to the drawing and the following description, like reference numbers are used to identify like or functionally similar elements, and are intended to illustrate major features of exemplary embodiments in a highly simplified diagrammatic manner. Moreover, the drawings are not intended to depict every feature of actual embodiment not the relative dimension of the depicted elements, and are not drawn to scale.

The present invention is directed to an optical transmitter for generating a modulated optical signal for transmission over dispersive fiber optic links in which a broadband radio frequency signal input is applied to first and second RF inputs of an external modulator for modulating the output of a semiconductor laser. The transmitter includes a digital signal processor coupled to the output of the modulator ro independently adjusting the DC bias of the first and second RF inputs to control a characteristic of the optical signal, such a noise associated with composite second order (CSO) distortion at a remote receiver.

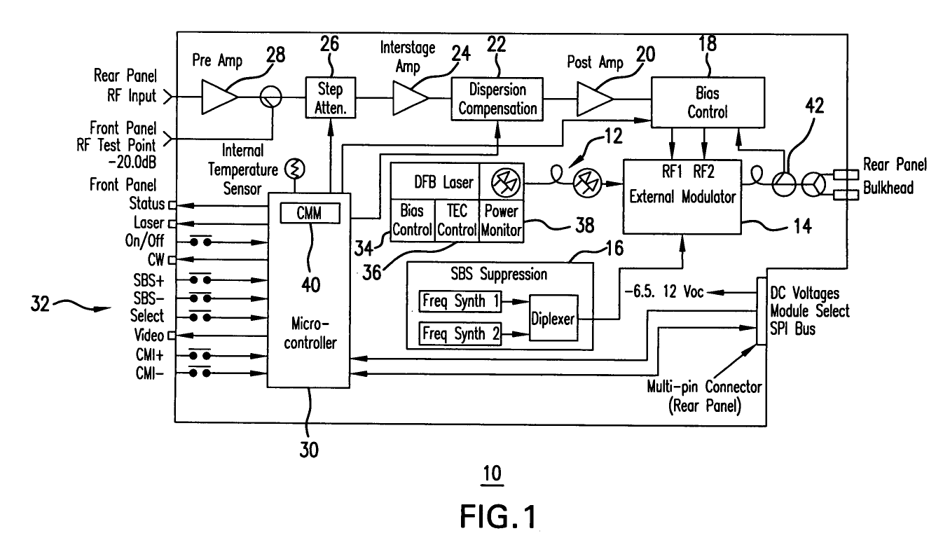

Turning to FIG. 1, there is shown a simplified block diagram of an optical transmitter 10 in an embodiment of the invention. The transmitter 10 includes a laser assembly (e.g., a DFB laser diode) 12 and an external modulator 14. The external modulator 14 modulates the CW output of the laser 12 with an information-containing pair of radio frequency signals (RF1, RF2), which are applied from a CSO demodulation and bias controller (modulation controller) 18.

The radio frequency (RF) signal from the user may be applied through an RF input on the external housing of the transmitter 10. The RF signal is then subjected to a number of processing steps before being applied to the external modulator 14 through the modulation controller 18. In addition to a number of amplification stages 20, 24, 28, the RF input may also be scaled through a step attenuator 26 operating under the control of a microcontroller 30. In order to control dispersion of an optical signal propagating from the transmitter 10, a dispersion compensation circuit (compensator) 22 may be provided under control of the microcontroller 30.

The modulation controller 18 includes predistortion circuitry that improves the composite triple beat (CTB) and composite second order beat (CSO) performance over a frequency range of 40 to 800 MHz, which is important for the application of the transmitter 10 as a central office transmitter for the transmission of CATV carriers and QAM signals in the frequency range of up to 870 MHz. The transmitter 10 may typically be used to transmit any combination of up to 112 carriers (e.g., 6 MHz channels) and QAM signals up to 870 MHz.

Some incidential features of the optical transmitter 10 may now be described, making reference to FIG. 1.

RF gain adjustments of the transmitter 10 may be performed through the use of a step attenuator 26 under control of the microcontroller 30. A feature of the present invention is that gain control is provided through the microcontroller 30, which may be controlled either manually using the +/−optical modulation index (OMI) buttons on a front panel 32, or automatically using gain adjustment software within the microcontroller 30.

The control circuitry of the transmitter 10 amplifies and predistorts the input RF signal that is then used to externally modulate the optical output of the DFB laser diode 12. The predistortion circuitry in the modulation bias controller 18 linearizes the optical signal by improving the distortion performance of the analog channels through appropriate cancellation circuitry.

Further features of the present invention include control circuits 34, 36, 38 that maintain constant optical output power and laser temperature. A laser monitoring module 40 within the microcontroller 30 monitors the control circuits 34, 36, 38 and reports any discrepancies to an external computer (not shown) through an SPI bus.

LEDs and an RF input testpoint on the front panel 32 allows a user to monitor the performance of the transmitter 10. The CMM software 40 provides enhanced monitoring and setup capability.

On the front panel of the optical transmitter, a status LED indicates the presence of alarms for the following parameters: laser bias current, laser temperature, module temperature, optical output power, and RF signal presence. The status LED may assume a green color to indicate that all monitored functions are operating within set limits. A yellow color may indicate that one or more monitored functions are operating beyond a minor alarm threshold, but has not exceeded a major threshold. A red color indicates that one or more functions is operating beyond a major alarm threshold. The status LED may blink during initialization or when the transmitter 10 is selected by the external computer through the SPI bus.

The laser LED on the front panel 32 may assume a green color to indicate the laser 12 is in an activated state. A yellow color may indicate that the laser 12 is in transition (as during initialization) or the output power is low. Red may indicate that the laser 12 is off. A blinking red color may indicate that a major threshold for laser bias current has been exceeded and the laser 12 is off.

An On/Off button on the front panel 30 may be used to toggle the laser 12 on or off after a 3 second delay. The On/Off button may be used to override an external comment from the external computer.

A CW LED is also provided on the front panel 32. The CW LED indicates that the laser 12 is operating in continuous wave (CW), automatic level control (ALC) mode.

An Up/Down SBS button is also provided on the front panel 32. These buttons can increase (+) or decrease (−) the SBS suppression for various EDFA launch powers in 0.5 dB increments. A default setting may be 16 dBm with an adjustment range of 12 to 18 dBm in 0.5 dB steps.

A select button may also be provided on the front panel 32. This pushbutton may be used to toggle the transmitter 10 among the ALC, CW, ALC video and manual modes.

A Video LED is also provided in the front panel 32. This LED indicates that the transmitter is operating in the video ALC mode.

A CW and a Video LED are also provided on the front panel. If both CW and Video LEDs are off, then the transmitter is in the manual mode.

A set of OMI Up/Down buttons are provided on the front panel 32. The Up and Down buttons may be activated to increase and decrease the OMI drive.

An RF test point is also provided on the front panel 32. The RF test point allows a user to measure the RF input at a level that is 20 dB lower than the RF input.

Turning now to the operation of the transmitter 10 in general, an RF signal to be transferred to the optical link enters the transmitter 10 through an F-connector on the transmitter's rear panel. For 80 NTSC analog channels the RF input level may be 20 dBmV per channel. The input signal may be amplified by the pre-amplifier 28 and routed to a directional coupler. The directional coupler directs a portion of the RF input to the RF testpoint on the front panel 32.

A low-loss port on the directional coupler passes the remaining portion of the RF input to the step attenuator 26. The step attenuator 26 provides attenuation from 0 to 6 dBm in 0.25 dB steps. The amount of attenuation may be controlled by the microcontroller 30 through the OMI buttons on the front panel 32. The output of the step attenuator 26 is then amplified by the interstage amplifier 24.

The output of the interstage amplifier 24 may then be provided as an input to the compensator 22. As is known, dispersion is a fiber optic transmission property that causes spectral components of modulated signals to travel at slightly different velocities, resulting in signal distortion. The compensator 22 is provided with a transfer function that is equivalent to the inverse dispersion properties of the fiber and that functions to realign the signal spectral components at the far end of the fiber. The output of the compensator 22 is then amplified by the post amplifier 20 and routed to the modulator control 18.

Turning now to the optical signal, the laser 12 provides optical signals at a wavelength of either 1545 +/−1nm, 1555 +/−5nm, or odd ITU channels 21 through 29, depending upon the application. The optical output of the laser 12 is coupled to the input of the modulator.

The external modulator 14 in the preferred embodiment consists of two series connected stages, each with a distinct RF input, RF1 and RF2. The output of the modulator is injected into an optical fiber, which is coupled to the transmission fiber optic link. A tap 42 is connected to the output to allow the output optical signal to be sampled. The sampled signal is coupled into a photodetector, which converts the optical signal into an electrical signal for processing.

The modulator control 18 has an RF input and two outputs RF1, RF2. The input from splitter (tap) 42 is used to set an operating point of the modulator 14 through output RF2 for purposes of controlling CSO performance. CSO bias control is accomplished by applying a control voltage (e.g., through RF1) to the modulator and then driving a null loop to hold the external modulator 14 at its symmetry point (e.g., through RF2). This nulls even-order distortions.

A DC symmetry point (i.e., a voltage that provides optimum biasing of) the external modulator 14 to achieve CSO cancellation may be separately determined by a calibration operation (or otherwise) and stored within a memory of the modulator control 18.

Rather than measuring input voltage, the modulator control 18 may measure an output signal from the tap 42 and store a set of symmetry voltages based upon the modulation of the output. During operation the modulation of the output optical signal may be measured and a symmetry point (voltage) may be retrieved from memory. The modulator bias control may be nulled against the retrieved value.

Another input to the modulator 14 is provided by the simulated Brillouin scattering (SBS) suppression circuit 16. The SBM circuit 16 uses a diplexer to combine the output of two frequency synthesizers. The output signal is used to phase modulate the modulator 14, which spreads out the spectral width and increases the SBS threshold.

Within the modulator 14, a dithering tone is received from the SBS suppressor 16 to broaden the linewidth of the laser input and increase the SBS threshold. As discussed above, the modulator 14 also receives two RF inputs from the modulator controller 18 to cancel even-order distortions. An output of the modulator 14 is used to provide two optical output signals through the rear of the transmitter through SC/APC connectors.

The laser 12 may include a number of monitoring circuits. In this regard, a photodetector within the power monitor 38 converts a sample of the optical output of the laser 12 into a DC voltage representing the power level. The power monitor 38 compares the DC voltage with a threshold saved within the power monitor 38 and generates an alarm when the DC voltage exceeds the threshold.

A laser bias control 34 within the laser 21 uses information from the power monitor 38 to adjust a bias of the laser and maintain a constant optical output power level. If the output power level exceeds a major threshold level stored within the bias control 34 or microcontroller 30, the microcontroller 30 turns off the laser. If the output power level exceeds a minor alarm threshold present within the controller 34 or microcontroller, the microcontroller 30 will generate an alarm.

Also present within the laser 12 is a thermoelectric controller 36 that includes a temperature sensor and thermoelectric cooler (TEC). The thermoelectric controller 36 monitors a temperature of the laser through the temperature sensor and uses the TEC to adjust the laser temperature accordingly.

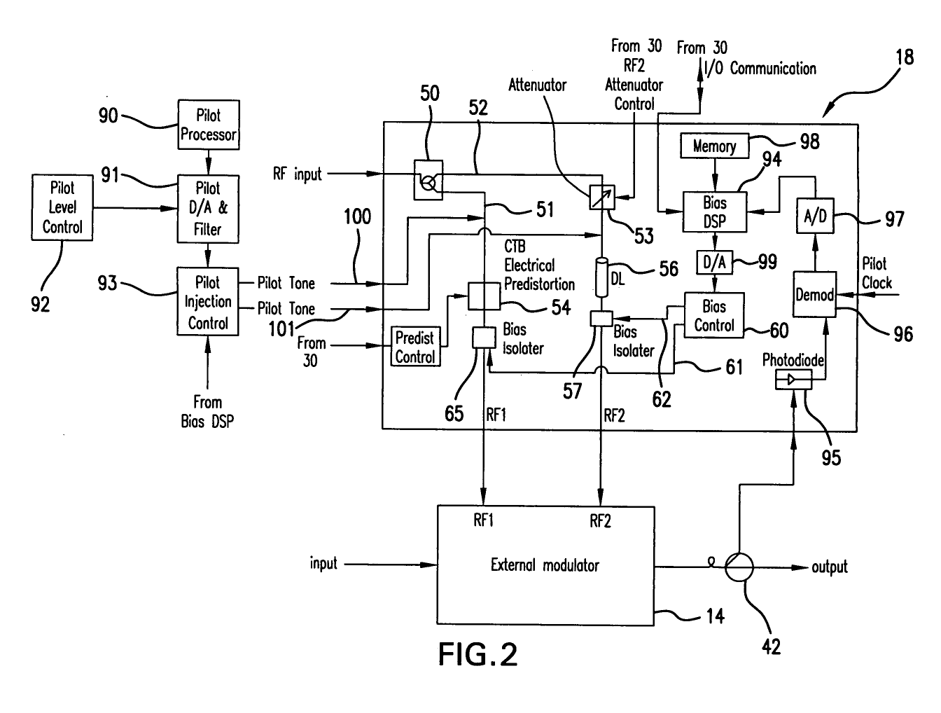

Turning next to FIG. 2, there is shown a more detailed view of the modulator control 18.

The RF input from the post amplifier 20 is applied to a signal splitter 50 which creates two RF channels 51 and 52. A first pilot tone is applied to the RF channel 51 from the pilot tone line 100. The signal on the first RF channel 51 is then applied to a CTB electrical predistortion circuit 54, for the purpose of reducing the CTB distortion at the receiver end of the optical fiber link. The DC level on the first RF channel 51 is controlled by a bias control unit 60, which sends an analog bias level to bias isolator 55 which couples the bias level to the RF channel 51, which is then applied to the first RF input, RF1, on the external modulator 14.

The signal on the second RF channel 52 is applied to an attenuator 53, which is controlled from the microcontroller 30. A second pilot tone is then applied to the output of the attenuator 53 from the pilot tone line 101. The combined signal is then applied to a delay line (DL) 56.

The DC level on the second RF channel 52 is controlled by a bias control unit 60, which sends an analog bias level to bias isolator 57 which couples the bias level to the RF channel 52, which is then applied to the second RF input, RF2, on the external modulator 14.

The pilot tones to be applied to the modulator are generated by a pilot processor 90, which produces a digital signal that is applied to a digital to analog converter and filter 91. The output of the pilot D/A and filter 91 is then applied to a pilot injection control unit 93. A pilot level control 92 and an input from the Bias DSP 94 sets the analog level. The pilot injection control 93 then switches the pilot tone to either line 100 or line 101, or both.

The bias DSP 94 also functions to adjust the modulator bias based upon measurements from the output optical signal from the external modulator 14. The digital signal processor 94 is coupled to the output of the modulator for independently adjusting the DC bias of the first and second RF inputs in response to a characteristic of the optical signal, such as the noise associated with composite second order (CSO) distortion at a remote receiver.

More particularly, the output from the tap 42 is coupled to a photo detector 95 which converts the optical signal into an electric signal. The electric signal is applied to a demodulator 96, along with a pilot clock signal. The demodulated analog RF signal is then applied to an analog to digital (A/D) converter 97, which provides a digital representation of the RF signal to the bias DSP 94. A memory 98 is also associated with the bias DSP 94 for storing data. The bias DSP also has an I/O communication line to and from the microcontroller 30 so that if required, the microcontroller 30 can override any of the bias points determined by the algorithms executed by the bias DSP 94.

In summary, one of the key aspects of the present invention is that, the sampled optical output, as an electrical signal, is converted by an analog-to-digital converter into a digital signal, which is applied to a digital signal processor (or, in alternative embodiments) microcontroller, to allow the output to be continuously analyzed and adjustments made on a real time basis.

Another aspect of the present invention is that the output of the bias digital signal processor is used to control the DC bias component of the respective RF signals applied to the first and second RF inputs of the external modulator 14, RF1 and RF2. The applied electrical signals have three components—a DC bias level, a pilot tone, and the applied RF information signal which modulates the laser beam and conveys the data or video signal to the remote receiver. The digital signal processor 94 uses an algorithm to set the appropriate DC bias level as a result of measurements on the optical signal. Since the characteristics of the optical signal will vary with time and temperatures, the output signal must be continuously monitored during operation and adjustments made to the DC bias levels.

Still another aspect of the present invention is the use of two distinct pilot tones or periodic signals applied to each respective RF inputs of the modulator. The use of pilot tones is known in the prior art such as represented by U.S. Pat. No. 6,490,071, however the present invention separately controls the pilot tones of the respective first and second inputs of the external modulator 14.

It will be understood that each of the elements described above, or two or more together, also may find a useful application in other types of constructions differing from the types describe above.

While the invention has been illustrated and described as embodied in an optical transmitter, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various application without omitting features that, from the standpoint of prior art, fairly constitute essential characteristics of the generic or specific aspects of this invention and, therefore, such adaptations should, and are intended to, be comprehensive within the meaning and range of equivalence of the following claims.

What is claimed is:

1. An optical transmitter for generating a modulated optical signal for transmission over a dispersive fiber optic link to a remote receiver comprising:
an input for receiving a broadband radio frequency signal input;
a semiconductor laser for producing an optical signal to be transmitted over an optical fiber;
an external modulator for modulating the optical signal with the analog signal, including first and second RF inputs; and
a predistortion circuit coupled to the first RF input for reducing the distortion in the signal present at the receiver end of the fiber optic link.

2. A transmitter as defined in claim 1, wherein the external modulator is a series coupled lithium niobate crystal modulator with the first RF input coupled to the first modulator, and the second RF input coupled to the second modulator.

3. A transmitter as defined in claim 1, wherein the wavelength of the light output of the laser is in the 1530 to 1570 nm range.

4. A transmitter as defined in claim 1, wherein the broadband signal input has a bandwidth greater than one octave and includes a plurality of distinct information carrying channels including both analog and QAM modulated channels.

5. A transmitter as defined in claim 1, further comprising a pilot tone generator for applying first and second distinct pilot tones to the first and second RF signal inputs respectively.

6. A transmitter as defined in claim 1, further comprising a dispersion compensation circuit that compensates for the distortion produced by the transmission of a frequency modulated optical signal through a dispersive fiber optic link as determined at the remote receiver end.

7. A transmitter as defined in claim 1, further comprising a microcontroller for independently adjusting the bias of said first and second RF inputs.

8. An optical transmitter for generating a modulated optical signal for transmission over a fiber optic link to a remote receiver comprising:
a semiconductor laser for producing an optical signal;
an external modulator for modulating the optical signal with a broadband analog radio frequency (RF) signal; and
bias adjustment means connected to the input of the external modulator for adapting the modulation characteristics of the external modulator to minimize distortion in the received signal at the remote receiver.

9. The transmitter as defined in claim 8, further comprising a digital signal processor coupled to said bias adjustment means for adjusting the DC bias of the external modulator during operation of the transmitter.

10. The transmitter as defined in claim 9, further comprising a tap connected to the output of said external modulator for measuring the modulation characteristics of the output signal.

11. The transmitter as defined in claim 8, wherein said external modulator includes a first stage and a second stage with independent RF inputs for each stage.

12. The transmitter as defined in claim 11, wherein the bias adjustment means independently adjusts the bias of the RF input of said first and second stages.

13. The transmitter as defined in claim 12, further comprising first and second pilot tone generators for applying first and second distinct pilot tones to said RF inputs.

14. An optical transmitter for generating a modulated optical signal for transmitting over a fiber optic link to a remote receiver comprising:
a semiconductor laser for producing an optical signal;
an external modulator for modulating the optical signal with an analog signal;
a first RF signal input to the external modulator having a first DC bias and a first pilot tone; and
a second RF signal input to the external modulator having a second DC bias and second pilot tone independent of said first DC bias and pilot tones.

15. The transmitter as defined in claim 14, wherein the external modulator includes first and second series connected stages each with a respective RF input.

16. A transmitter as defined in claim 14, wherein the external modulator has a optical signal output including a tap for enabling the output optical signal to be sampled, and further comprising a photodetector coupled to said tap for converting the output optical signal into an analog electrical signal, and an analog-to-digital converter for converting the analog electrical signal into a digital signal.

17. The transmitter as defined in claim 16, further comprising bias adjustment means connected to the RF signal inputs of the external modulator for adapting the modulation characteristics of the optical signal to the number and modulation types of the RF signal.

18. The transmitter as defined in claim 17, further comprising a digital signal processor coupled to said bias adjustment means for processing said digital signal and continuously adjusting the bias of said first and second RF signal inputs.

19. The transmitter as defined in claim 18, further comprising a software algorithm for continuously sampling the digital signal from the analog-to-digital converter for determining the adjustment of the bias.

20. A method of operating an optical transmitter for transmission of an optical signal over a dispersive fiber optic media to a remote receiver comprising:
sampling the output optical signal at the transmitter at periodic intervals;
converting the output optical signals into a digital signal;
processing the digital signal to determine the appropriate bias to be applied to a modulator to modulate the optical signal; and
adjusting the bias of the modulator to minimize the distortions at the remote receiver.
